(19) United States
(12) Patent Application Publication
(10) Pub. No.: US 2007/0074822 A1
(43) Pub. Date: Apr. 5, 2007

(54) Apparatus for peeling adhesive tape

(75) Inventor: Takeshi Akechi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 10/575,682

(22) PCT Filed: Oct. 7, 2004
(86) PCT No.: PCT/JP04/14820

§ 371 Date: Apr. 13, 2006

(30) Foreign Application Priority Data
Oct. 17, 2003 (JP) 2003-357168

(51) Int. Cl. B29C 63/00

(52) U.S. Cl. 156/584; 156/344

(57) ABSTRACT

An apparatus for peeling an adhesive tape is provided for enabling fragmented adhesive tapes to be readily and efficiently peeled from a plate-shaped member.

The apparatus for peeling a surface protection tape (adhesive tape) 2a adhered on the surface of a wafer (plate-shaped member) W and fragmented into chip-size pieces from the wafer W comprises peeling tape supplying means 20 for feeding a peeling tape 3 to the wafer W set on a suction table 10; peeling tape adhering means for adhering the peeling tape 3 fed out by the peeling tape supplying means 20 over the entire surface of the surface protection tape 2a adhered on the surface of the wafer W; heating means for heating the peeling tape adhered over the entire surface of the adhesive tape by the peeling tape adhering means together with the adhesive tape; tape peeling means for peeling the adhesive tape sticking to the peeling tape through the heating by the heating means from the plate-shaped.

### TECHNICAL FIELD

The present invention relates to an apparatus for peeling an adhesive tape from a plate-shaped member, such as a surface protection tape adhered on the surface of the plate-shaped member of a semiconductor wafer or the like which has been fragmented into chip-size pieces.

### BACKGROUND ART

In a semiconductor chip manufacturing process in electronic industries and optical industries, after predetermined circuit patterns have been formed on the surface of a semiconductor wafer (hereinafter simply called the “wafer”), the rear surface of the wafer is ground in order to uniformly reduce the thickness of the wafer or in order to remove an oxide film generated during the formation of the circuits, followed by dicing (fragment) the wafer into individual circuits to manufacture semiconductor chips.

Incidentally, grinding debris can be produced during the grinding of a wafer, and if the grinding debris come in contact with a circuit pattern, the circuit pattern can be broken.

Therefore, a method has been employed for adhering a surface protection tape on the surface of a wafer to protect the surface of the wafer, grinding the wafer in this state, and peeling the surface protection tape from the surface of the wafer after the grinding, and a peeling apparatus has also been proposed for implementing this method (see Patent Document 1).

Also, the dicing (fragment) of a wafer into individual circuits results in the production of cutting debris, and even the cutting debris, if coming into contact with a circuit pattern, can also break the circuit pattern, so that a method has been proposed for dicing the wafer with the surface protection tape remaining adhered on the surface of the wafer, and peeling the fragmented surface protection tapes from the surface of the wafer after the dicing (see Patent Document 2).

[Patent Document 1] Laid-Open Japanese Patent Application No. 11-16862.

[Patent Document 2] Laid-Open Japanese Patent Application No. 8-22330093.

### DISCLOSURE OF THE INVENTION

### Problem to be Solved by the Invention

However, the peeling apparatus described in Patent Document 1 is an apparatus for peeling a surface protection tape from a wafer before it is diced, so that the wafer is diced after the surface protection tape has been peeled therefrom, thus possibly causing the aforementioned problem due to cutting debris which are produced by the dicing and contact to circuit patterns.

The peeling method described in Patent Document 2 involves adhering a surface protection tape having an adhesive layer on a heat-shrinkable base onto a plate-shaped member, and substantially heating only the heat-shrinkable base when the surface protection tape is peeled off, thereby shrinking and curving the fragmented surface protection tapes to reduce their contact areas to the plate-shaped members, thus making it easier to peel the surface protection tape from the plate-shaped member.

However, the foregoing peeling method entails the removal of the respective shrunk and curved surface protection tapes from the surface of the plate-shaped member by such means as blasting, absorption, and peeling with the aid of an adhesive tape, and has a problem of a low efficiency because this operation is manually performed in most cases.

The present invention has been made in view of the problems mentioned above, and it is an object of the invention to provide an apparatus for peeling an adhesive tape, which is capable of readily and efficiently peeling fragmented adhesive tapes from plate-shaped members.

### Means for Solving the Problem

To achieve the above object, the invention set forth in claim 1 is characterized by an apparatus for peeling an adhesive tape adhered on a surface of a plate-shaped member and fragmented in chip-size pieces from the plate-shaped member, wherein the adhesive tape peeling apparatus comprises:

peeling tape supplying means for feeding a peeling tape to the plate-shaped member set on a suction table;

peeling tape adhering means for adhering the peeling tape fed out by the peeling tape supplying means over an entire surface of the adhesive tape adhered on the surface of the plate-shaped member;

heating means for heating the peeling tape adhered on the entire surface of the adhesive tape by the peeling tape adhering means together with the adhesive tape;

peeling means for peeling the adhesive tape sticking to the peeling tape through heating by the heating means from the plate-shaped member together with the peeling tape; and

collecting means for collecting the adhesive tape and the peeling tape peeled from the plate-shaped member by the tape peeling means.

The invention set forth in claim 2 is characterized in that a continuous sheet-shaped tape is used as the peeling tape, and the peeling tape adhering means and the tape peeling means are implemented by a common roller unit in the invention set forth in claim 1.

The invention set forth in claim 3 is characterized in that a tape previously cut in conformity of the surface shape of the plate-shaped member is used as the peeling tape, wherein a second adhesive tape adhered to an end of the peeling tape is held and pulled by a peeling head, thereby peeling the adhesive tape from the plate-shape member together with the peeling tape in the invention set forth in claim 1.

The invention set forth in claim 4 is characterized in that the adhesive tape comprises an adhesive layer deposited on a heat-shrinkable base in the invention set forth in claim 1.

The invention set forth in claim 5 is characterized in that the adhesive-layer of the adhesive tape is made of an ultraviolet curable adhesive, and the apparatus further comprises an ultraviolet ray irradiating means for irradiating the adhesive tape with ultraviolet rays in the invention set forth in claim 4.

The invention set forth in claim 6 is characterized by comprising cooling means for cooling the peeling tape and the adhesive tape heated by the heating means in the invention set forth in claim 1.

### Effects of the Invention

According to the invention set forth in claim 1, as the peeling tape adhered over the entire surface of the adhesive tape is heated together with the adhesive tape, the fragmented adhesive tapes stick to the peeling tape, so that the adhesive tapes are peeled from the plate-shaped member together with the peeling tape, and the peeled adhesive tapes and peeling tape are collected, thereby making it possible to readily peel the fragmented adhesive tapes from the plate-shaped member. A sequence of these steps are performed by the peeling apparatus which comprises the peeling tape supplying means, peeling tape adhering means, heating means, tape peeling means, and collecting means, thereby making it possible to efficiently carry out the operation for peeling the adhesive tapes.

According to the invention set forth in claim 2, since a continuous sheet-shaped tape is used as the peeling tape, the fragmented adhesive tapes can be successively adhered to the continuous sheet-shaped member to efficiently peel the adhesive tapes from the plate-shaped member for collecting. Also, by implementing the peeling tape adhering means and tape peeling means by a common roller unit, the peeling apparatus can be simplified in structure and reduced in cost.

According to the invention set forth in claim 3, a tape previously cut in conformity to the surface shape of the plate-shaped member is used as the peeling tape. By holding and pulling a second adhesive tape adhered to an end of the peeling tape by a peeling head, the adhesive tape can be readily and efficiently peeled from the plate-shaped member together with the peeling tape.

According to the invention set forth in claim 4, since a tape comprising an adhesive layer deposited on a heat-shrinkable base is used as the adhesive tape, the heat-shrinkable base shrinks as the adhesive tape is heated, causing the respective fragmented adhesive tapes to curve and therefore be in contact with the plate-shaped member in a reduced area. Thus, each adhesive tape more readily peels from the plate-shaped member, and they readily stick to the peeling tape and are peeled from the plate-shaped member and collected together with the peeling tape.

According to the invention set forth in claim 5, as ultraviolet rays are irradiated to an adhesive tape having an adhesive layer made of an ultraviolet curable adhesive by the ultraviolet ray irradiating means, the adhesive layer of the adhesive tape is cured to weaken the adhesive strength of the adhesive tape, causing each of the fragmented adhesive tapes to more readily peel from the plate-shaped member. They are readily peeled from the plate-shaped member together with the peeling tape for collect.

According to the invention set forth in claim 6, by cooling the heated peeling tape and adhesive tape, the operation time can be reduced to further increase the efficiency.

### BRIEF DESCRIPTION OF THE DRAWINGS

FIG. 1 A side view of a peeling apparatus according to a first embodiment of the present invention.

FIG. 2 A top plan view of the peeling apparatus according to the first embodiment of the present invention.

FIG. 3 A side view of a suction table section of the peeling apparatus according to the first embodiment of the present invention.

FIG. 4 A top plan view of the suction table section of the peeling apparatus according to the first embodiment of the present invention.

FIG. 5 A cross-sectional view of a wafer with a surface protection tape adhered on the surface thereof.

FIG. 6 A cross-sectional view of the surface protection tape.

FIG. 7 An explanatory diagram illustrating a peeling method implemented using the peeling apparatus according to the first embodiment of the present invention in the order of steps.

FIG. 8 An explanatory diagram illustrating the peeling method implemented using the peeling apparatus according to the first embodiment of the present invention in the order of steps.

FIG. 9 An explanatory diagram illustrating the peeling method implemented using the peeling apparatus according to the first embodiment of the present invention in the order of steps.

FIG. 10 An explanatory diagram illustrating the peeling method implemented using the peeling apparatus according to the first embodiment of the present invention in the order of steps.

FIG. 11 An explanatory diagram illustrating the peeling method implemented using the peeling apparatus according to the first embodiment of the present invention in the order of steps.

FIG. 12 An explanatory diagram illustrating the peeling method implemented using the peeling apparatus according to the first embodiment of the present invention in the order of steps.

FIG. 13 An explanatory diagram illustrating the peeling method implemented using the peeling apparatus according to the first embodiment of the present invention in the order of steps.

FIG. 14 An explanatory diagram illustrating the peeling method implemented using the peeling apparatus according to the first embodiment of the present invention in the order of steps.

FIG. 15 A cross-sectional view of a wafer with a surface protection tape and a peeling tape adhered on the surface thereof in the peeling method which is implemented using the peeling apparatus according to the first embodiment of the present invention.

FIG. 16 A cross-sectional view illustrating how a peeling tape is adhered to the surface protection tape on the surface of the wafer after heating in the peeling method which is implemented using the peeling apparatus according to the first embodiment of the present invention.

FIG. 17 A top plan view of a peeling apparatus according to a second embodiment of the present invention.

FIG. 18 An explanatory diagram illustrating a peeling method implemented using a peeling apparatus according to a third embodiment of the present invention in the order of steps.

FIG. 19 An explanatory diagram illustrating the peeling method implemented using the peeling apparatus according to the third embodiment of the present invention in the order of steps.

FIG. 20 An explanatory diagram illustrating the peeling method implemented using the peeling apparatus according to the third embodiment of the present invention in the order of steps.

FIG. 21 A cross-sectional view illustrating the state of a surface protection tape and a peeling tape after heating in the peeling method which is implemented using the peeling apparatus according to the third embodiment of the present invention.

FIG. 22 A cross-sectional view illustrating how the peeling tape and surface protection tape are peeled from the surface of a wafer in the peeling method which is implemented using the peeling apparatus according to the third embodiment of the present invention.

### DESCRIPTION OF REFERENCE NUMERALS

1 Peeling Apparatus
2 Surface Protection Tape (Adhesive Tape)
2A Heat-Shrinkable Base
2B Adhesive Layer
2a Fragmented Surface Protection Tape (Adhesive Tape)
3 Peeling Tape
3a Release Liner
10 Suction Table
11 Ring Frame
20 Peeling Tape Unit (Peeling Tape Supplying Means)
21 Peeling Tape Stock
25 Release liner Wind Shaft
30 Adhesion/peeling Roller Unit (Peeling Tape Adhering Means/Tape Peeling Means)
31, 32 Rollers
35 Uniaxial Moving Robot
37 Up/Down Cylinder
40 Heating/Cooling Unit (Heating Means/Cooling Means)
41 Heater Body
44 Sliding Cylinder
50 Tape Wind Unit (Collecting Means)
55 Peeling Tape Wind Shaft
61 Peeling Tape Stock
62-65 Rollers
66 Wind Shaft
67 Adhesive Tape
68 Peeling Head
70 Frame Chucking Unit
71 Frame Cassette
72 Sliding Rail
73 Table
74 Guide Rail
75 Sliding Rail
76 Slider
77 Frame Chuck
80 UV Irradiating Unit (Ultraviolet Ray Irradiating Means)
90 Carrier Unit
91 Suction Arm
92 Sliding Rail
93 Slider
94 Sliding Rail
95 Supporting Arm
96 Slider
W Semiconductor Wafer (Plate-Shaped Member)
W1 Fragmented Semiconductor Wafers
M1-M4 Motors

### Best Mode for Carrying Out the Invention

In the following, embodiments of the present invention be described with reference to the accompanying drawings.

<First Embodiment>

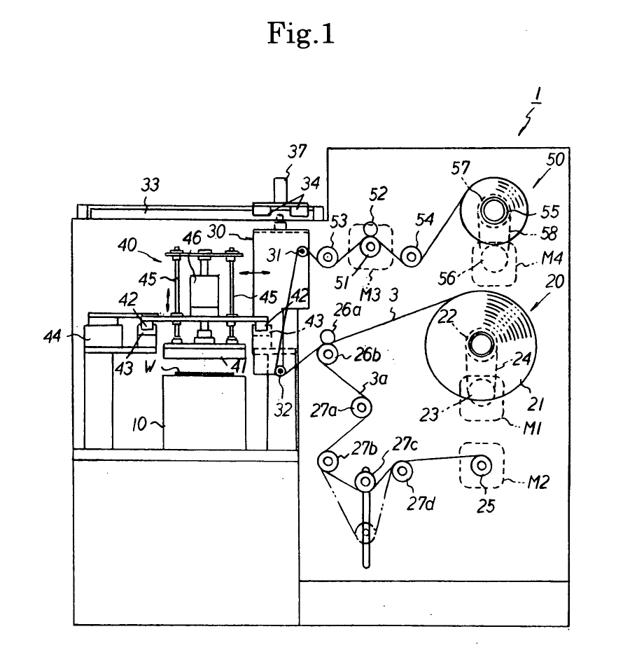

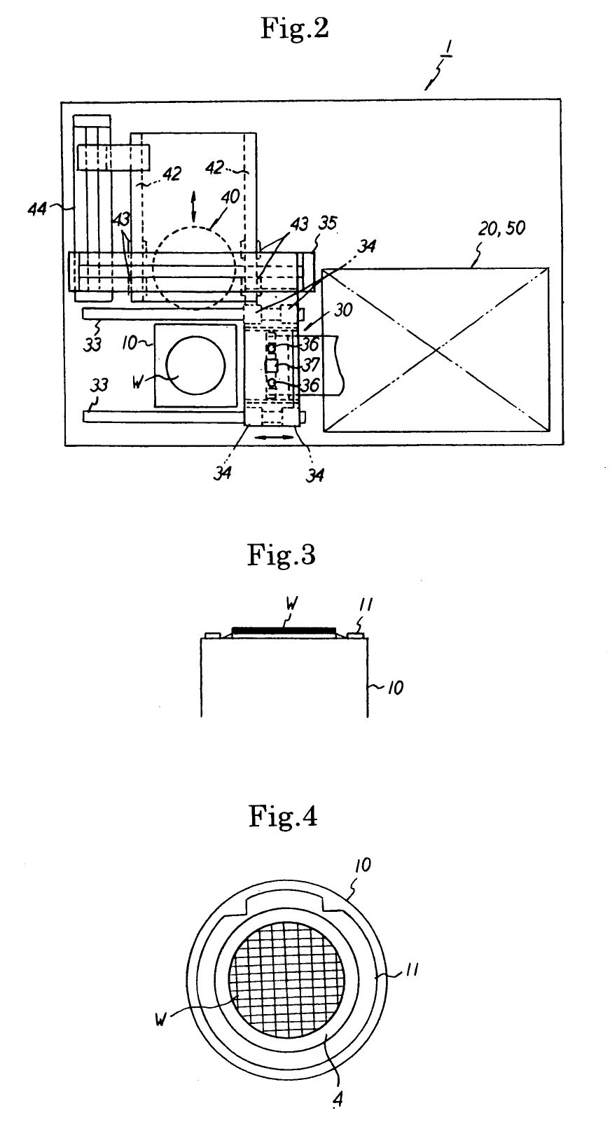

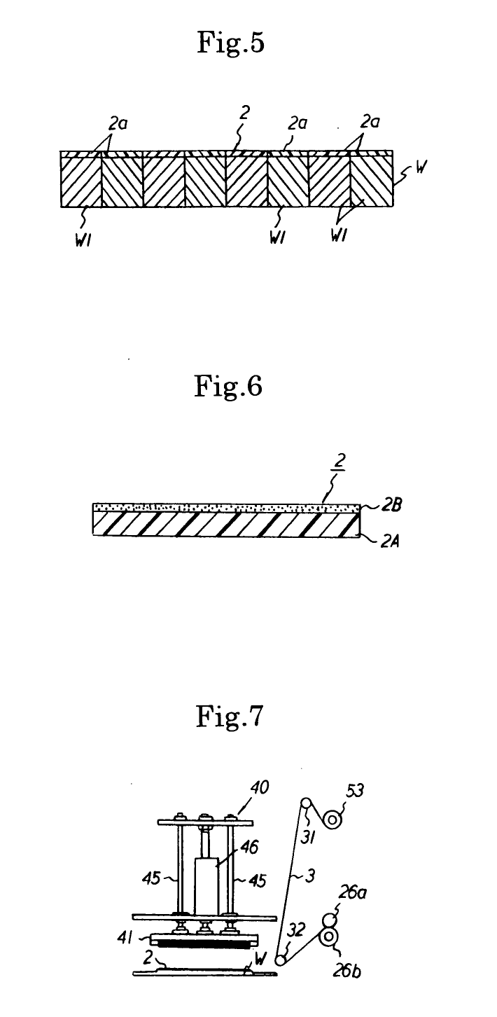

FIG. 1 is a side view of a peeling apparatus according to a embodiment of the present invention, FIG. 2 is a top plan view of peeling apparatus, FIG. 3 is a side view of a suction table section of the peeling apparatus, FIG. 4 is a top plan view of the suction table section, FIG. 5 is a cross-sectional view of a wafer with a surface protection tape (adhesive tape) adhered on the surface thereof, and FIG. 6 is a cross-sectional view of the surface protection tape (adhesive tape).

The peeling apparatus 1 according to this embodiment is an apparatus for peeling the surface protection tape 2a, which has been adhered on a wafer W and fragmented as illustrated in FIG. 5, from the surface of the wafer W in a semiconductor manufacturing process.

Here, a surface protection tape 2 is adhered on the surface of the wafer W after predetermined circuit patterns have been formed thereon, as illustrated in FIG. 5, and the rear surface of the wafer W is ground in that state. Subsequently, the wafer W is diced (fragmented) together with the surface protection tape 2 on a circuit-by-circuit basis. For reference sake, in FIG. 5, 2a designates fragmented surface protection tapes, and W1 fragmented wafers.

Incidentally, the surface protection tape 2 comprises an adhesive layer 2B coated on the surface of a heat-shrinkable base 2A made of sufficiently stretched polyethylene, as illustrated in FIG. 6. The adhesive layer 2B made of an acrylic-based adhesive agent is adhered on the surface of the wafer W, thereby adhering the surface protection tape 2 on the surface of the wafer W.

As illustrated in FIG. 1, the peeling apparatus 1 according to this embodiment comprises:

1) a suction table 10;

2) a peeling tape unit 20 which is a peeling tape supplying means for feeding out a peeling tape 3 to the wafer W which is set on the suction table 10;

3) an adhesion/peeling roller unit 30 having an integration of a peeling tape adhering means for adhering the peeling tape 3 fed out by the peeling tape unit 20 over the entire surface of the surface protection tape 2 (2a) adhered on the surface of the wafer W, and a tape peeling means for peeling the surface protection tape 2 (2a) sticking to the peeling tape 3 from the surface of the wafer W together with the peeling tape 3 by applying heat from a heating/cooling unit 40, later described;

4) the heating/cooling unit 40 having an integration of a heating means for heating the peeling tape 3 adhered over the entire surface of the surface protection tape 2 (2a) by the adhesion/peeling roller unit 30 together with the surface protection tape 2 (2a), and a cooling means for cooling the peeling tape 3 and surface protection tape 2 (2a) heated by the heating means; and

5) a tape wind unit 50 which is collecting means for collecting the surface protection tape 2 (2a) and peeling tape 3 peeled from the surface of the wafer W by the adhesion/peeling roller unit 30.

Here, a detailed description will be hereinafter given of each of the suction table 10, peeling tape unit 20, adhesion/peeling roller unit 30, heating/cooling unit 40, and tape wind unit 50.

1) Suction Table:

As illustrated in FIG. 4, the wafer W is fixed to a ring frame 11 through a dicing tape 4 on the opposite side to the surface on which the surface protection tape 2 is adhered, and is fragmented, together with the surface protection tape 2; they are positioned and carried on the cylindrical suction table 10. The ring frame 11 and wafer W are both held by sucking the lower surfaces thereof.

For reference sake, while the peeling tape 3 is adhered over the entire surface of the surface protection tape 2 adhered on the surface of the wafer W by the adhesion/peeling roller unit 30, as will be later described, the level of the ring frame 11 is set lower than the surface of the wafer W by one step in this event such that the peeling tape 3 does not stick to the ring frame 11.

2) Peeling Tape Unit:

As illustrated in FIG. 1, in the peeling tape unit 20, a roll-shaped peeling tape stock 21, with the peeling tape 3 wound there around, is rotatably supported, and a pulley 22 is coupled to a shaft of the peeling tape stock 21. Then, a torque motor M1 is disposed near the peeling tape stock 21, and an endless belt 24 is wound around a pulley 23 coupled to an output shaft end of the torque motor M1 and the pulley 22.

Here, used for the peeling tape 3 is a heat sensitive tape having a heat sensitive adhesive layer deposited on a heat resistant film such as polyethylene terephthalate, and the heat sensitive adhesive layer is covered with a release liner 3a.

Another motor M2 is disposed below the torque motor M1, and a release liner wind shaft 25 is coupled to an output shaft of the motor M2 for winding the release liner 3a separated from the peeling tape 3.

Further, the peeling tape unit 20 comprises a pair of upper and lower rollers 26a, 26b for sandwiching the peeling tape 3 fed out of the peeling tape stock 21 to separate the release liner 3a from the peeling tape 3; and guide rollers 27a-27d for guiding the release liner 3a separated from the peeling tape 3. Here, one guide roller 27c constitutes a buffer roller which can move up and down along a guide groove 28 formed in the vertical direction. This buffer roller 27c is urged downward at all times by an urging means, not shown, to perform a function of drawing the release liner 3a to prevent it from sagging.

3) Adhesion/Peeling Roller Unit:

As illustrated in FIG. 1, the adhesion/peeling roller unit 30 comprises two rotatably supported rollers 31, 32 arranged one above the other, which are movably supported through a slide track 34 to a pair of sliding rails 33 disposed in parallel on the body of the apparatus. Then, the adhesion/peeling roller unit 30 is reciprocally moved in the directions indicated in the figure on the sliding rails 33 by an uniaxial moving robot 35 (see FIG. 2) which is disposed in parallel with the sliding rails 33 on the body of the apparatus.

Also, as illustrated in FIG. 2, the adhesion/peeling roller unit 30 is supported for movement along two guide shafts 36 arranged one above the other, and is moved up and down along the guide shafts 36 by up/down cylinder 37.

The peeling tape 3, from which the release liner 3a has been separated, is wound around the rollers 31, 32 of the adhesion/peeling roller unit 30.

4) Heating/Cooling Unit:

As illustrated in FIG. 1, the heating/cooling unit 40 comprises a heater body 41 as a heating means, and a cooling means, not shown, such as a cooling fan or the like, and is supported to a pair of left and right sliding rails 42 perpendicular to the sliding rails 33 for movement in a direction perpendicular to the sheet of FIG. 1 through a slide track 43. Then, a sliding cylinder 44 is arranged in parallel with the sliding rails 42 for reciprocally moving the heating/cooling unit 40 through the sliding rails 42 (see FIG. 2).

Also, in the heating/cooling unit 40, the heater body 41 is supported such that it can move up and down along a plurality of guide shafts 45, and the heater body 41 is moved up and down by an up/down cylinder 46 (see FIG. 1).

5) Tape Wind Unit:

As illustrated in FIG. 1, the tape wind unit 50 is disposed above the peeling tape unit 20. This tape wind unit 50 comprises a feed roller 51 driven by a motor M3 to rotate; a pinch roller 52 in contact with and driven by the feed roller 51 for rotation; guide rollers 53, 54 arranged on both sides of the pinch roller 52; and a peeling tape wind shaft 55 for winding the peeling tape 3 together with the surface protection tape 2 (2a) sticking thereto. In addition, a torque motor M4 is disposed near the peeling tape wind shaft 55, and an endless belt 58 is wound around a pulley 56 coupled to an output shaft end of the torque motor M4 and a pulley 57 coupled to the peeling tape wind shaft 55.

The peeling tape 3 fed to the tape wind unit 50 through the roller 31 of the adhesion/peeling roller unit 30, and the surface protection tape 2 (2a) sticking thereto are sandwiched by the feed roller 51 and pinch roller 52 through the guide roller 53, reach the peeling tape wind shaft 55 through the guide roller 54, and wound around and collected the peeling tape wind shaft 55.

Next, a method of peeling the fragmented surface protection tapes 2a will be described with reference to FIGS. 7 to 16 while describing the action of the peeling apparatus 1 which has the foregoing configuration. FIGS. 7 to 14 are explanatory diagrams showing the peeling method in the order of steps, FIG. 15 is a cross-sectional view illustrating how the peeling tape is adhered to the surface protection tape on the surface of a wafer, and FIG. 16 is a cross-sectional view illustrating the state of the surface protection tape and peeling tape after heating.

The peeling method according to this embodiment is a method of peeling the surface protection tapes 2a adhered on the surface of the wafer W and fragmented into chip-size pieces from the surface of the wafers W1 which have also been fragmented in the same manner, and is implemented through the following peeling tape adhering step, heating/cooling step, and tape peeling step.

1) Peeling Tape Adhering Step:

As illustrated in FIG. 3, the wafer W with the surface protection tape 2 adhered on the surface thereof is positioned inside the ring frame 11 on the suction table 10 with the surface protection tape 2 oriented upward, and is set through suction together with the ring frame 11 through a dicing tape 4. The surface protection tape 2 is fragmented by dicing into chip-size pieces together with the wafer W

First, the adhesion/peeling roller unit 30 is waiting at a position shown in FIGS. 1 and 2, where the two rollers 31, 32 of the adhesion/peeling roller unit 30 stay at positions shown in FIG. 7, forcing the peeling tape 3 stretched therebetween to wait aside of the wafer W.

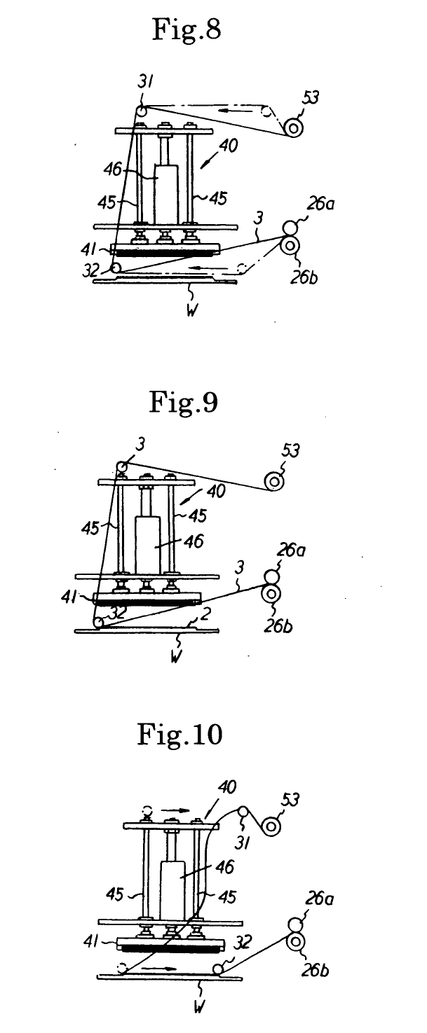

In the foregoing state, as the uniaxial moving robot 35 is driven to move the adhesion/peeling roller unit 30 in the left direction in FIGS. 1 and 2 along the sliding rails 33, the rollers 31, 32 of the adhesion/peeling roller unit 30 move in the direction indicated by the arrow from a chain line position to a solid line position in FIG. 8. In this event, the motor M3 remains locked, and is moved with the movements of the rollers 31, 32 while drawing out the peeling tape 3 separated from the release liner 3a from the peeling tape stock 21. Above the wafer W, the peeling tape 3, stretched between the roller 32 and the roller pair 26a, 26b, is positioned on the slant.

Incidentally, while the peeling tape 3 is being drawn out, the peeling tape 3 is applied with a predetermined tension by the torque motor M1. Also, the release liner 3a, when it is drawn out, has its sag absorbed because the buffer roller 27c is moved to a position indicated by a chain line in FIG. 1 by an urging means. Then, as the peeling tape 3 has been adhered to the wafer W, the motor M2 starts operating to wind up the release liner 3a when the buffer roller 27c is detected by a sensor, not shown.

Next, the up/down cylinder 37 is driven to move the adhesion/peeling roller unit 30 down along the guide shaft 36 to bring the roller 32 into close contact with one end of the surface of the wafer W together with the peeling tape 3, as illustrated in FIG. 9. As a result, the peeling tape 3 is adhered to one end of the surface protection tape 2 (2a) adhered on the surface of the wafer W, and the uniaxial moving robot 35 is driven in that state to move the adhesion/peeling roller unit 30 in the right direction in FIGS. 1 and 2 along the sliding rails 33.

Then, the rollers 31, 32 of the adhesion/peeling roller unit 30 move in the direction indicated by the arrow from a chain line position to a solid line position in FIG. 10, and the roller 32 moves while pressing the peeling tape 3 onto the surface protection tape 2 (2a) on the surface of the wafer W, causing the peeling tape 3 to be adhered over the entire surface of the surface protection tape 2 (see FIG. 15).

2) Heating/cooling Step:

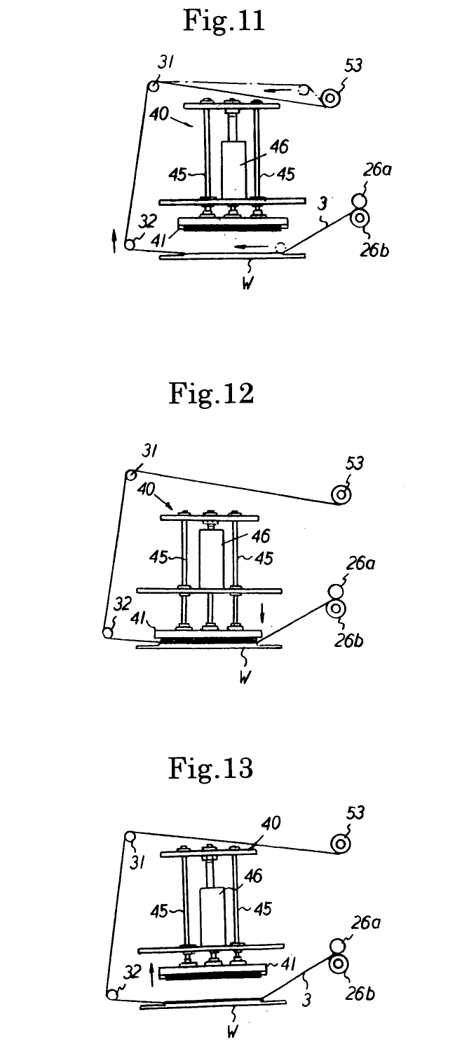

When the peeling tape 3 has been adhered over the entire surface of the surface protection tape 2 in the peeling tape adhering step, the uniaxial moving robot 35 is again driven to move the adhesion/peeling roller unit 30 in the left direction in FIGS. 1 and 2 along the sliding rails 33. Then, the up/down cylinder 37 is driven to move the adhesion/peeling roller unit 30 up along the guide shaft 36, causing the roller 32 to move away from the surface of the wafer W. Consequently, the rollers 31, 32 of the adhesion/peeling roller unit 30 move in the direction indicated by the arrow from a chain line position to a solid line FIG. 11.

In the foregoing state, the sliding cylinder 44 is driven to move the heating/cooling unit 40 down in FIG. 2 along the sliding rails 42 such that the heating/cooling unit 40 is positioned above the wafer

Subsequently, the up/down cylinder 46 of the heating/cooling unit 40 is driven to move the heater body 41 of the heating/cooling unit 40 down along the guide shafts 45, and the heater body 41 is brought into contact with the peeling tape 3 which has been adhered to the surface protection tape 2 (2a) on the surface of the wafer W, as illustrated in FIG. 12. Then, in this state, a heater in the heater body 41 is supplied with electric power to heat the peeling tape 3 and surface protection tape 2 (2a) to a predetermined temperature.

Here, the heating temperature and heating time, though depending on the material of the surface protection tape 2, are typically on the order of 40 to 200° C. (preferably 70 to 130° C.) and 0.5 to 120 seconds (preferably, 1 to 10 seconds).

As described above (see FIG. 6), the surface protection tape 2 includes the adhesive layer 2B coated on the surface of the heat-shrinkable base 2A, so that if it is heated, the heat shrinkable base 2A shrinks, causing the respective fragmented surface protection tapes 2a to curve as illustrated in FIG. 16. Thus, the individual fragmented surface protection tapes 2a are in contact with the surface of the wafer W (W1) in a reduced area to peel easily each surface protection tape 2a peel from the surface of the wafer W (W1).

Subsequently, the up/down cylinder 46 is driven to move upward the heater body 41 of the heating/cooling unit 40 up along the guide shaft 45 to move the heater body 41 away from the wafer W, as illustrated in FIG. 13. In this state, the peeling tape 3 and surface protection tape 2 are cooled down by a cooling means, not shown, such as a cooling fan or the like.

3) Tape Peeling Step:

When the peeling tape 3 and surface protection tape 2 have been cooled down in the foregoing manner, the sliding cylinder 44 is driven to move the heating/cooling unit 40 upward in FIG. 2 along the sliding rails 42, thus retracting the heating/cooling unit 40 away from above the wafer W.

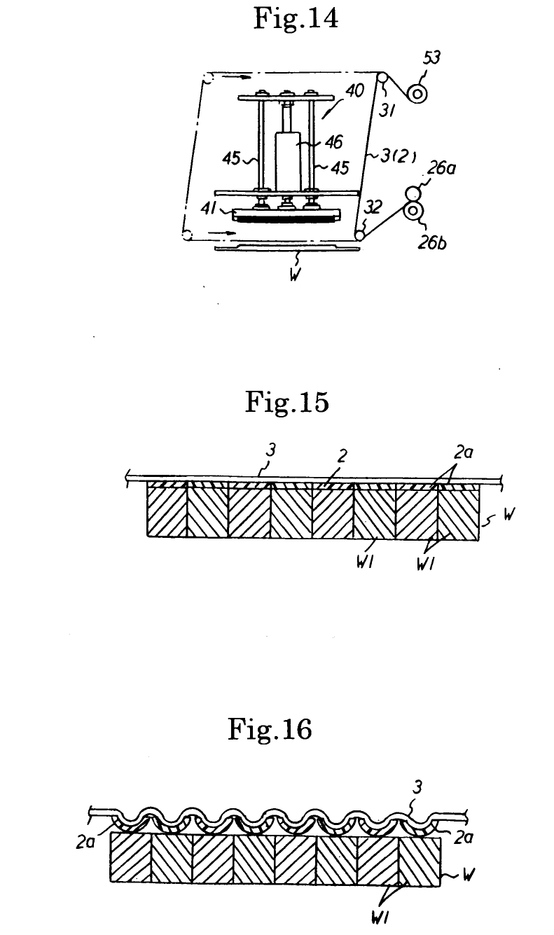

Subsequently, as the uniaxial moving robot 35 is driven to move the adhesion/peeling roller unit 30 along the sliding rails 33 in the right direction in FIGS. 1 and 2, the rollers 31, 32 of the adhesion/peeling roller unit 30 move in the direction indicated by the arrow from a chain line to a solid line in FIG. 14, and in this event, the motor M3 and torque motor M4 are driven simultaneously. Here, since a predetermined tension is applied to the peeling tape 3, the rotation of the torque motor M4 is transmitted to the tape wind shaft 55 through the pulley 56, belt 58, and pulley 57 to rotate the tape wind shaft 55, thus causing the peeling tape 3 to peel off the surface of the wafer W, together with the surface protection tape 2 (2a) which sticks to the peeling tape 3.

Here, as described above (see FIG. 16), since the respective fragmented surface protection tapes 2a are curved and therefore more easily peeled from the surface of the wafer W, these surface protection tapes 2a stick to the peeling tape 3 and are readily peeled from the surface of the wafer W.

Then, the peeling tape 3 peeled from the surface of the wafer W is wound around the tape wind shaft 55 of the tape wind unit 50, together with the surface protection tape 2a sticking thereto, for collecting.

In the foregoing, according to this embodiment, as the peeling tape 3 adhered over the entire surface of the surface protection tape 2 is heated together with the surface protection tape 2 (2a), the fragmented surface protection tapes 2a shrink while they stick to the peeling tape 3, so that the fragmented surface protection tape 2a can be readily peeled from the surface of the wafer W, wherein the operation for peeling the surface protection tape 2 (2a) can be efficiently carried out by performing a sequence of these steps by the peeling apparatus 1 which comprises the suction table 10, peeling tape unit 20, adhesion/peeling roller unit 30, heating/cooling unit 40, and tape wind unit 50.

Also, in this embodiment, a continuous sheet tape is used for the peeling tape 3, so that the fragmented surface protection tapes 2a can be successively adhered to the continuous peeling tape 3 and efficiently peeled off from the surface of the wafer W for collecting.

Further, in this embodiment, since the peeling tape adhering means and tape peeling means are implemented by the common adhesion/peeling roller unit 30, the peeling apparatus 1 can be simplified in structure and reduced in cost.

Otherwise, in this embodiment, since the heated peeling tape 3 and surface protection tape 2 (2a) are cooled down, the operating time can be reduced to further increase the efficiency.

While part of the operations (for example, setting the wafer W on the suction table 10) is manually performed in the peeling apparatus 1 according to this embodiment, a fully automatic peeling apparatus can be realized as well if it is configured to automatically perform all the operations.

<Second Embodiment>

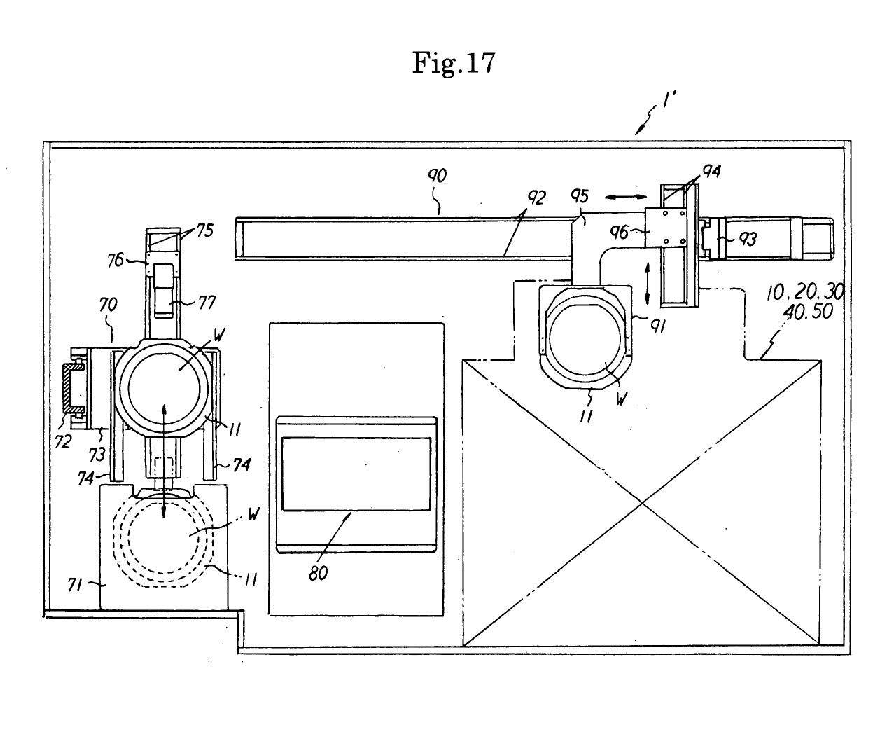

Next, a second embodiment of the present invention will be described with reference to FIG. 17. FIG. 17 is a top plan view of a peeling apparatus according to this embodiment.

The peeling apparatus 1′ according to this embodiment additionally comprises a frame chucking unit 70 for automatically bringing and removing a wafer (integrated with the ring frame 11) into and from a frame cassette 71; and a UV irradiation unit 80 for irradiating ultraviolet rays (UV) to a surface protection tape 2 (2a) which has an adhesive layer 2B, shown in FIG. 2B, made of an ultraviolet curable adhesive, and the remaining configuration is the same as that of the peeling apparatus 1 according to the first embodiment, i.e., comprises the suction table 10, peeling tape unit 20, adhesion/peeling roller unit 30, heating/cooling unit 40, and tape wind unit 50.

The frame chucking unit 70 extracts one of a plurality of wafers W stored in the frame cassette 71 which are arranged with a proper space defined therebetween in the vertical direction, peels the surface protection tape 2 (2a) from the surface of the extracted wafer W, and places the wafer W, from which the surface protection tape 2 (2a) has been peeled, into the frame cassette 71, and comprises a table 73 which moves up and down along a sliding rail 72 arranged in the vertical direction. In addition, a pair of guide rails 74 are arranged on the table 73 to extend in parallel with each other toward an opening of the frame cassette 71. A pair of sliding rails 75 are arranged in parallel between these guide rails 74.

A slider 76 is slidably disposed on the sliding rails 75 such that it can reciprocally move on the sliding rails 75, and a frame chuck 77 is attached to the slider 76 for chucking the wafer W (actually, a ring frame 11).

The UV irradiation unit 80 in turn irradiates ultraviolet rays (UV) to the surface protection tape 2 (2a) adhered on the surface of the wafer W. As the wafer W supported by a suction arm 91 of a carrier unit 90 passes above the UV irradiation unit 80 with the surface protection tape 2 (2a) oriented downward, the surface protection tape 2 (2a) is irradiated with ultraviolet rays.

Here, the carrier unit 90 comprises a pair of sliding rails 92 arranged in a direction perpendicular to the sliding rails 75 and in parallel with each other, and a slider 93 is slidably arranged on the sliding rails 92. Then, a pair of sliding rails 94, perpendicular to the sliding rails 92 and parallel with each other, are supported by the slider 93 to be slidable up and down (vertical direction on the sheet of FIG. 17) along the slider 93. An L-shaped supporting arm 95 has a leading end supported by the suction arm 91, and a proximal end slidably supported by the sliding rails 94 through the slider 96. The supporting arm 95 is provided with a mechanism, not shown, which can reverse the suction arm 91 upside down.

In the operation for peeling off the surface protection tape 2 (2a) from a plurality of wafers W stored in the frame cassette 71, the table 73 of the frame chucking unit 70 is moved up and down along the sliding rails 72, and stopped the movement when the table 73 reaches a desired height position of the wafers W. The frame chuck 77 slides on the sliding rails 75 toward the frame cassette 71, chucks and extracts a desired wafer W (actually, the ring frame 11) from the frame cassette 71, moves the wafer W integrated with the ring frame 11 along the guide rails 74, and carries them to a predetermined position indicated by a solid line in FIG. 17.

Next, the carrier unit 90 is driven to move the suction arm 91 attached to the leading end of the supporting arm 95 toward the frame chucking unit 70 along the sliding rails 92, and also move the suction arm 91 along the sliding rails 94 to a position indicated by a solid line in FIG. 17 above the waiting wafer W. Then, the suction arm 91 is moved down along the slider 93, and sucks the ring frame 11 to support the wafer W together with the ring frame 11. Then, the suction arm 91 is again moved up and transferred along the sliding rails 92, to pass the wafer W above the UV irradiation unit 80 along the sliding rails 92, so that the surface protection tape 2 (2a) adhered on the surface of the wafer W is irradiated with ultraviolet rays (UV). Consequently, the ultraviolet curable adhesive of the surface protection tape 2 (2a) is cured to weaken the adhesive strength of the surface protection tape 2 (2a) to the surface of the wafer W In this event, the wafer W is supported in such an orientation that its surface on which the surface protection tape 2 (2a) is adhered faces downward.

When the surface protection tape 2 (2a) has been irradiated with ultraviolet rays as described above, the suction arm 91 is moved along the sliding rails 92 of the carrier unit 90, reverses the wafer W upside down, and sets the wafer W on the suction table 10 with the surface on which the surface protection tape 2 is adhered facing upward, in a manner similar to the peeling apparatus 1 according to the aforementioned first embodiment. Thereafter, the surface protection tape 2 (2a) adhered on the surface of the wafer W is peeled from the wafer W and removed therefrom in a manner similar process according to the aforementioned first embodiment.

Then, the wafer W, from which the fragmented surface protection tapes 2a have been peeled and removed, is sucked by the suction arm 91, carried to a predetermined position (position indicated by a solid line in FIG. 17) on the guide rails 74 of the frame chucking unit 70, and sent toward the frame cassette 71 along the guide rails 74 by the slider 76, while it remains chucked by the frame chuck 77, for storage at a predetermined location in the frame cassette 71.

By repeating the foregoing operations, the surface protection tapes 2 (2a) can be fully automatically peeled from the surfaces of a plurality of wafers W, thus saving the labor and improving the operational efficiency.

Also, in the peeling apparatus 1′ according to this embodiment, the surface protection tape 2 (2a) is irradiated with ultraviolet rays by the UV irradiation unit 80 as a previous step, so that the ultraviolet curable adhesive of the surface protection tape 2 (2a) is cured to weaken the adhesive strength of the surface protection tape 2 (2a). Thus, the fragmented surface protection tapes 2a can be more readily peeled from the surface of the wafer W, so that they are readily peeled from the surface of the wafer W together with the peeling tape 3 for collecting.

Otherwise, the peeling apparatus 1′ according to this embodiment also provides similar effects to those provided in the aforementioned first embodiment.

<Third Embodiment>

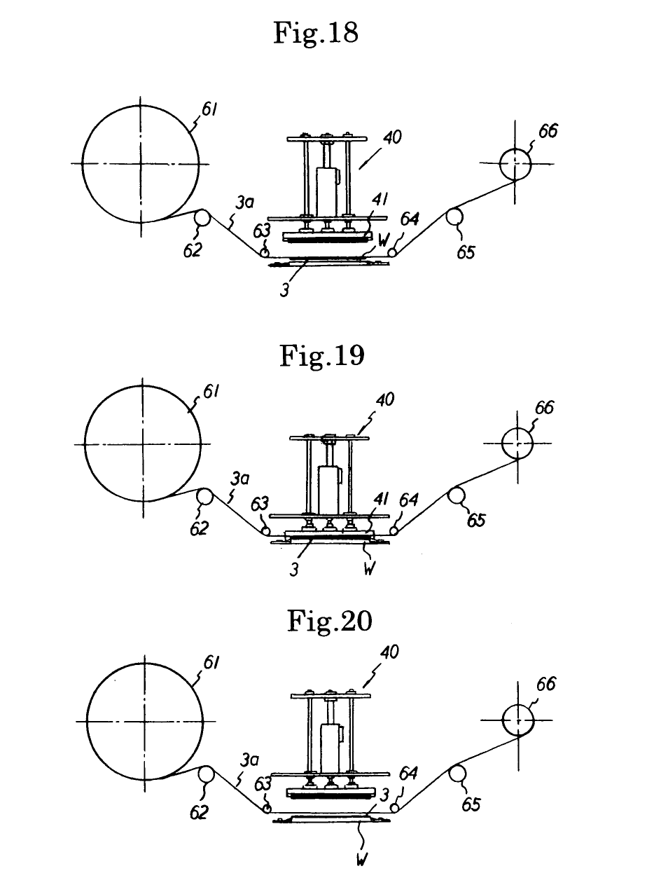

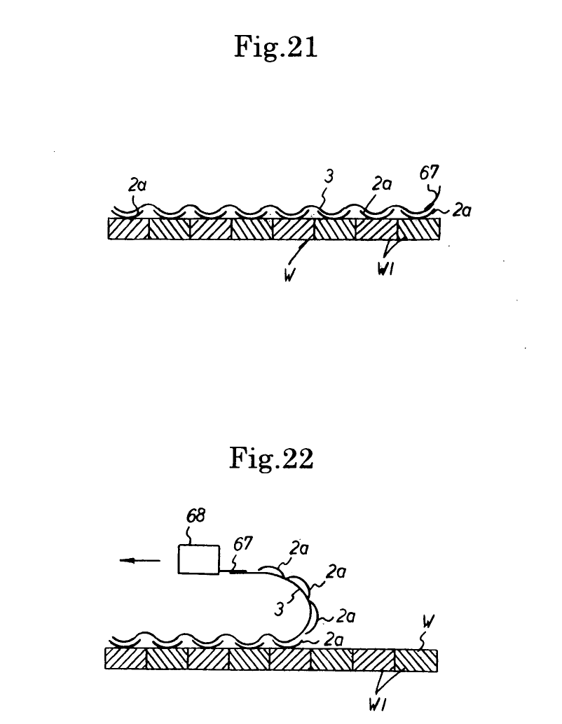

Next, a third embodiment of the present invention will be described with reference to FIGS. 18 to 22. FIG. 18-20 are explanatory diagrams illustrating a peeling method which is implemented using a peeling apparatus according to the third embodiment of the present invention in the order of steps, FIG. 21 is a cross-sectional view illustrating the state of a heated surface protection tape and peeling tape, and FIG. 22 is a cross-sectional view illustrating how the peeling tape and surface protection tape are peeled from the surface of a wafer.

The peeling method according to this embodiment is a method of peeling surface protection tapes 2a adhered on the surface of a wafer W and fragmented into chip-size pieces from the surface of the wafer W, as is the case with the aforementioned first and second embodiments, but differs from the first and second embodiment in that a circular tape previously cut in conformity to the surface shape of the wafer W is used as the peeling tape 3.

Specifically, in this embodiment, a plurality of circular peeling tapes 3, which had been previously cut in conformity to the surface shape of the wafer W, have been temporarily adhered on a sheet-shaped release liner 3a wound around a peeling tape stock 61 at proper intervals, as illustrated in FIG. 18. The release liner 3a fed out from the peeling tape stock 61 is guided by rollers 62-65 and wound around a wind shaft 66.

Here, the surface protection tape 2 has an adhesive layer coated on the surface of a heat-shrinkable base, in a manner similar to the aforementioned first embodiment, while used as the peeling tape 3 is a thermally sensitive adhesion tape which has a thermally sensitive adhesive layer deposited on a heat resistant film such as polyethylene terephthalate.

As illustrated in FIG. 18, the release liner 3a is substantially horizontally stretched above the wafer W by two rollers 63, 64, and a circular peeling tape 3 temporarily adhered on the lower surface of the release liner 3a is positioned above the wafer W.

Next, the heater body 41 of the heating/cooling unit 30 is moved down, such that the heater body 41 presses the peeling tape 3 onto the surface protection tape 2 on the surface of the wafer W, and heats the peeling tape 3 to a predetermined temperature together with the surface protection tape 2, as illustrated in FIG. 19. As a result, the peeling tape 3, which has been previously cut in a circular shape, is adhered onto the entire surface of the surface protection tape 2 on the surface of the wafer W.

As described above, the surface protection tape 2 has the adhesive layer coated on the surface of a heat-shrinkable base, so that when it is heated, the heat-shrinkable base shrinks, causing the respective fragmented surface protection tapes 2a to curve, as illustrated in FIG. 21. Thus, each of the fragmented surface protection tapes 2a is in contact with the surface of the wafer W in a reduced area, causing each surface protection tape 2a to more readily peel off the surface of the wafer W.

Subsequently, as the heater body 41 of the heating/cooling unit 40 is moved up, the peeling tape 3 is separated from the release liner 3a and remains on the surface of the wafer W, as illustrated in FIG. 20, so that the release liner 3a alone is guided by the rollers 64, 65 and wound around the wind shaft 66.

Next, as illustrated in FIG. 21, one end of an adhesive tape 67 is adhered to one end of the peeling tape 3 which has been adhered over the entire surface of the surface protection tape on the surface of the wafer W, and this adhesive tape 67 is folded back in a laterally U-shape, as illustrated in FIG. 22. Then, when the other end of the adhesive tape 67 is nipped by a peeling head 68, and moved in a direction indicated by an arrow in FIG. 22, the peeling tape 3 and the surface protection tapes 2a sticking thereto are pulled by the peeling head 68 and sequentially peeled from the surface of the wafer W for collecting.

Here, as described above, the respective fragmented surface protection tapes 2a are curved and therefore tend to readily peel off the surface of the wafer W, so that these surface protection tapes 2a stick to the peeling tape 3, and readily peel off the surface of the wafer W.

As described above, this embodiment can also readily and efficiently peel the fragmented surface protection tapes 2a from the surface of the wafer W, and therefore provides similar effects to those of the aforementioned first embodiment.

### INDUSTRIAL AVAILABILITY

The present invention can be applied to methods and apparatus for peeling an adhesive tape such as a surface protection tape adhered on the surface of a plate-shaped member and fragmented in chip-size pieces from the plate-shaped member, and is available in the field of manufacturing of optical devices and electronic components such as lenses, wavelength converting device and the like, other than the field of semiconductor manufacturing.

1. An apparatus for peeling an adhesive tape adhered on a surface of a plate-shaped member and fragmented in chip-size pieces from said plate-shaped member, said adhesive tape peeling apparatus characterized by comprising:
peeling tape supplying means for feeding a peeling tape to said plate-shaped member set on a suction table;
peeling tape adhering means for adhering the peeling tape fed out by said peeling tape supplying means over an entire surface of said adhesive tape adhered on the surface of the plate-shaped member;
heating means for heating the peeling tape adhered on the entire surface of the adhesive tape by said peeling tape adhering means together with the adhesive tape;
peeling means for peeling the adhesive tape sticking to the peeling tape through heating by said heating means from the plate-shaped member together with the peeling tape; and
collecting means for collecting the adhesive tape and the peeling tape peeled from the plate-shaped member by said tape peeling means.

2. An adhesive tape peeling apparatus according to claim 1, characterized in that a continuous sheet-shaped tape is used as said peeling tape, and said peeling tape adhering means and said tape peeling means are implemented by a common roller unit.

3. An adhesive tape peeling apparatus according to claim 1, characterized in that a tape previously cut in conformity of the surface shape of said plate-shaped member is used as said peeling tape, wherein a second adhesive tape adhered to an end of the peeling tape is held and pulled by a peeling head, thereby peeling said adhesive tape from the plate-shape member together with the peeling tape.

4. An adhesive tape peeling apparatus according to claim 1, characterized in that said adhesive tape comprises an adhesive layer deposited on a heat-shrinkable base.

5. An adhesive tape peeling apparatus according to claim 4, characterized in that said adhesive layer of the adhesive tape is made of an ultraviolet curable adhesive, wherein said apparatus further comprises an ultraviolet ray irradiating means for irradiating the adhesive tape with ultraviolet rays.

6. An adhesive tape peeling apparatus according to claim 1, characterized by comprising cooling means for cooling the peeling tape and the adhesive tape heated by said heating means.
